(19) United States
(12) Patent Application Publication
(10) Pub. No.: US 2023/0119267 A1
(43) Pub. Date: Apr. 20, 2023

(54) System for Providing Lubrication to a Machine

(71) Applicant: Industrial Matrix, North York (CA)

(72) Inventor: Steven PAMENSKY, Thornhill (CA)

(21) Appl. No.: 17/960,889

(22) Filed: Oct. 6, 2022

Related U.S. Application Data
(60) Provisional application No. 63/255,588, filed on Oct. 14, 2021.

(51) Int. Cl. F16N 29/02; F01M 11/00; G01M 13/045

(52) U.S. Cl. CPC F16N 29/02; F01M 11/00; G01M 13/045; F01M 2250/60; F16N 2270/70

(57) ABSTRACT

A system for providing lubrication to a machine. The system comprises at least one ultrasound sensor positioned to detect sound emanating from at least one lubrication point of the machine, and at least one auto-lubrication device configured to provide lubrication to the at least one lubrication point. The at least one auto-lubrication device is controlled to provide lubrication to the at least one lubrication point based at least in part on sound detection data from the at least one ultrasound sensor.

### RELATED APPLICATION

This application claims priority to the Oct. 14, 2021 filing date of U.S. Provisional Patent Application No. 63/255,588, which is incorporated herein by reference.

### FIELD OF THE INVENTION

This invention relates to a system for providing lubrication to a machine, and more particularly to a system with an auto-lubrication device that provides lubrication to a machine based at least in part on sound detected by an ultrasound sensor.

### BACKGROUND OF THE INVENTION

Many industrial machines have moving parts, such as bearings, that require lubrication in order to function properly. As the machines operate, the lubrication may become depleted, which can lead to overheating, excess wear and tear, and component failure. To avoid these problems, the lubrication needs to be replenished periodically.

The process of replenishing lubrication can be cumbersome. For example, in some machines the lubrication levels are checked manually on a periodic basis. This may require the machines to be at least partially disassembled, requiring significant labor costs as well as down time for the machines. To reduce these costs, the operators of the machines may delay checking the lubrication levels, which can lead to undetected lubrication depletion and the resulting problems of overheating and component failure.

### SUMMARY OF THE INVENTION

To at least partially overcome some of the disadvantages of previously known systems, methods and devices, the present invention provides a system for providing lubrication to a machine, the system including at least one ultrasound sensor and at least one auto-lubrication device. The ultrasound sensor is positioned to detect sound emanating from at least one lubrication point of the machine, such as a bearing. The at least one auto-lubrication device is configured to provide lubrication to the at least one lubrication point based at least in part on sound detection data from the at least one ultrasound sensor.

The inventor of the present invention has appreciated that, as the lubrication level is depleted, the sound emanating from a component requiring lubrication, such as a bearing, will increase. This increase in sound can be detected by the ultrasound sensor, and used to automatically control the auto-lubrication device to provide lubrication to the component when needed.

In an especially preferred embodiment of the invention, the system can further include at least one radio node that receives sound detection data from the ultrasound sensor, and transmits the sound detection data to a cloud-based lubrication control application. The sound detection data can then be analyzed by the cloud-based lubrication control application to inform decisions about the lubrication of the machine. For example, the cloud-based lubrication control application can compare the detected sound level to a threshold level. If the detected sound level exceeds the threshold level, the cloud-based lubrication control application can send instructions via the radio node to the auto-lubrication device to provide lubrication to the component. The threshold level may be selected, for example, based on the known or estimated sound level that emanates from the component when the lubrication level is depleted.

The cloud-based lubrication control application preferably receives data from multiple ultrasound sensors that are configured to detect the sound emanating from multiple lubrication points. The cloud-based lubrication control application then preferably analyzes the sound detection data to determine if any of the multiple lubrication points require lubrication. If a subset of one or more of the multiple lubrication points are determined to require lubrication, the cloud-based lubrication control application sends instructions via the radio node to the auto-lubrication device to provide lubrication to the subset of the multiple lubrication points.

In one preferred embodiment, the auto-lubrication device includes a lubrication pump with a lubrication reservoir; multiple lubrication lines that connect the lubrication pump to each of the multiple lubrication points; and multiple solenoid valves that each control a flow of the lubrication through one of the multiple lubrication lines to one of the multiple lubrication points. When the cloud-based lubrication control application determines that a subset of the multiple lubrication points require lubrication, the cloud-based lubrication control application sends instructions via the radio node to a subset of the multiple solenoid valves to provide lubrication to only those lubrication points that have been determined to require lubrication.

Preferably, the cloud-based lubrication control application has access to stored data pertaining to the operation and lubrication needs of the machine. The stored data may include, for example, information provided by a manufacturer of the machine regarding the lubrication requirements of the machine. The data may also include historical data regarding past lubrication events and sound levels.

Optionally, the cloud-based lubrication control application may be configured to control the replenishment of lubrication based at least in part on the stored data. For example, the cloud-based lubrication control application may be configured to replenish the lubrication in a machine based on a preselected schedule, with data from the ultrasound sensors being used for identifying when a component requires additional lubrication ahead of schedule. The cloud-based lubrication control application may be configured to adjust the lubrication schedule based on the sound detection data received from the ultrasound sensors over time. Optionally, the cloud-based lubrication control application may be configured to trigger a maintenance event if a particular component is found to require replenishment of lubrication more frequently than would be expected based on the schedule. In some embodiments, the data from the ultrasound sensors may be used to create a database of information about the lubrication needs of the machine, which can then be used to generate a lubrication schedule for the machine.

Preferably, the cloud-based lubrication control application has a user interface, which may for example be accessible to authorized users via a computer or mobile device. The user interface may, for example, allow authorized users to access data regarding the operation of the machine and the lubrication system. The user interface may also allow users to modify or input data and commands, such as to select the threshold sound levels required to trigger replenishment of lubrication in the various components of the machine. The threshold sound levels may optionally be the same or different for the various components. The user may also be enabled to set, select and/or adjust the lubrication schedule or other parameters of the system. For example, the user may be able to select a volume of lubrication that is to be provided to each component when that component requires lubrication. Optionally, the cloud-based lubrication control application can control the lubrication of multiple industrial machines, and the lubrication of all of the machines can be controlled and/or adjusted by the user via the user interface.

In some preferred embodiments, the radio node is configured to transmit sound detection data from the ultrasound sensors at regular intervals, such as every 10 seconds, every 30 seconds, every minute, or every 5 minutes. The cloud-based lubrication control application is optionally configured to analyze the sound detection data received over time to determine whether the various components of the machine require lubrication. For example, the cloud-based lubrication control application may be configured to calculate an average sound level produced by a component over a given time interval, such as 10 minutes or the last 10 data points, and compare this average sound level to a threshold level. By averaging the sound level over time, the system can preferably avoid making lubrication decisions based on anomalous detection data, such as stray sounds that the ultrasound sensors may pick up on occasion from the environment. The sound level may, for example, be measured in decibels.

Accordingly, in one aspect the present invention resides in a system for providing lubrication to a machine, the system comprising: at least one sound sensor positioned to detect sound emanating from at least one lubrication point of the machine; and at least one auto-lubrication device configured to provide lubrication to the at least one lubrication point; wherein the at least one auto-lubrication device is controlled to provide lubrication to the at least one lubrication point based at least in part on sound detection data from the at least one sound sensor.

In some embodiments, the system further comprises at least one communication device configured to receive the sound detection data from the at least one sound sensor and to transmit the sound detection data to a lubrication control application; wherein the lubrication control application controls the at least one auto-lubrication device based at least in part on the sound detection data.

Preferably, the lubrication control application is configured to analyze the sound detection data to determine whether the at least one lubrication point is producing sounds indicative of a need for lubrication; and the lubrication control application, upon determining that the at least one lubrication point is producing sounds indicative of a need for lubrication, sends instructions via the at least one communication device to the at least one auto-lubrication device to provide lubrication to the at least one lubrication point.

Optionally, the at least one communication device transmits the sound detection data to the lubrication control application at set intervals over time; and the lubrication control application analyzes the sound detection data received over multiple intervals to determine whether the at least one lubrication point requires lubrication.

In some embodiments, the lubrication control application calculates an average sound level based on the sound detection data received over a plurality of the set intervals, and compares the average sound level to a threshold sound level; and the lubrication control application, upon determining that the average sound level exceeds the threshold sound level, controls the at least one auto-lubrication device to provide lubrication to the at least one lubrication point.

In some embodiments, the at least one communication device transmits the sound detection data to the lubrication control application about once every minute; and the lubrication control application calculates the average sound level based on the sound detection data received over a time period of about 10 minutes.

Optionally, the lubrication control application controls the at least one auto-lubrication device based in part on stored data related to lubrication requirements of the machine.

In some embodiments, the lubrication control application is configured to determine, based on the sound detection data, whether the sound emanating from the at least one lubrication point exceeds a threshold value; and the lubrication control application, upon determining that the sound emanating from the at least one lubrication point exceeds the threshold value, controls the at least one auto-lubrication device to provide lubrication to the at least one lubrication point until the sound emanating from the at least one lubrication point falls to or below the threshold value.

In some preferred embodiments, the at least one sound sensor comprises multiple sound sensors, and the at least one lubrication point comprises multiple lubrication points; wherein each of the multiple sound sensors is positioned to detect the sound emanating from a respective one of the multiple lubrication points; wherein the at least one auto-lubrication device comprises: a lubrication pump with a lubrication reservoir; multiple lubrication lines that connect the lubrication pump to each of the multiple lubrication points; and multiple valves that each control a flow of the lubrication through one of the multiple lubrication lines to one of the multiple lubrication points; wherein the at least one communication device receives the sound detection data from each of the multiple sound sensors and transmits the sound detection data to the lubrication control application; wherein the lubrication control application analyzes the sound detection data to determine if any of the multiple lubrication points require lubrication; and wherein the lubrication control application, upon determining that a subset of the multiple lubrication points require lubrication, sends instructions via the at least one communication device to a subset of the multiple valves to provide lubrication to the subset of the multiple lubrication points.

Preferably, the at least one sound sensor comprises at least one ultrasound sensor.

Preferably, the at least one communication device comprises at least one radio node.

Preferably, the lubrication control application comprises a cloud-based lubrication control application.

Preferably, the valves comprise solenoid valves.

In some embodiments, the lubrication control application is configured to generate or adjust a lubrication schedule for the machine based at least in part on the sound detection data received from the at least one sound sensor over time.

In another aspect, the present invention resides in a method of providing lubrication to a machine, comprising: positioning at least one sound sensor to detect sound emanating from at least one lubrication point of the machine; and controlling at least one auto-lubrication device to provide lubrication to the at least one lubrication point based at least in part on sound detection data from the at least one sound sensor.

### BRIEF DESCRIPTION OF THE DRAWINGS

Further aspects and advantages of the invention will appear from the following description taken together with the accompanying drawings, in which:

FIG. 1 is a schematic representation of a system in accordance with a first embodiment of the present invention; and

FIG. 2 is a schematic representation of a system in accordance with a second embodiment of the present invention.

### DETAILED DESCRIPTION OF THE DRAWINGS

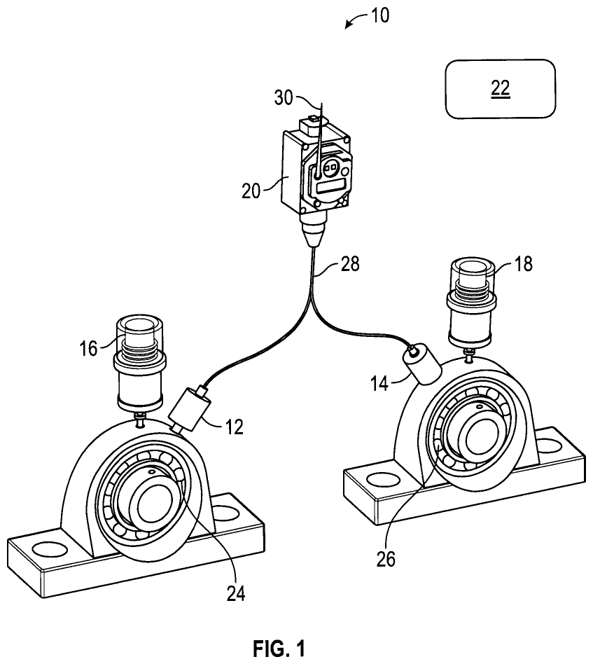

FIG. 1 shows a system 10 for providing lubrication to a machine in accordance with a first embodiment of the present invention. The system 10 includes a first ultrasound sensor 12, a second ultrasound sensor 14, a first auto-lubrication device 16, a second auto-lubrication device 18, a radio node 20, and a cloud-based lubrication control application 22.

The first ultrasound sensor 12 is positioned adjacent to a first lubrication point 24 of a machine, for detecting sounds emanating from the first lubrication point 24. The first lubrication point 24 is a component of the machine requiring lubrication, such as a bearing. The first ultrasound sensor 12 is connected to the radio node 20 by a wire 28.

The second ultrasound sensor 14 is positioned adjacent to a second lubrication point 26 of the machine, for detecting sounds emanating from the second lubrication point 26. The second lubrication point 26 is also a component of the machine requiring lubrication, such as a bearing. The second ultrasound sensor 14 is also connected to the radio node 20 by a wire 28.

The first auto-lubrication device 16 is connected to the first lubrication point 24 for delivering lubrication to the first lubrication point 24, and the second auto-lubrication device 18 is connected to the second lubrication point 26 for delivering lubrication to the second lubrication point 26. Each of the first auto-lubrication device 16 and the second auto-lubrication device 18 contain a supply of lubrication and have a pump mechanism, not shown, for delivering the lubrication.

The radio node 20 is spaced from the first lubrication point 24 and the second lubrication point 26, and has a radio transmitter 30 for communicating with the cloud-based lubrication control application 22 wirelessly via radio waves. The radio node 20 is connected to the first ultrasound sensor 12 and the second ultrasound sensor 14 via the wires 28. The radio node 20 is also preferably able to communicate with the first auto-lubrication device 16 and with the second auto-lubrication device 18 via a wired connection, not shown, or wirelessly.

The cloud-based lubrication control application 22, shown schematically in FIG. 1, is software installed on remote computers and/or computer servers. The cloud-based lubrication control application 22 is able to communicate with the radio node 20. Optionally, the computers and/or computer servers running the cloud-based lubrication control application 22 communicate directly with the radio node 20 wirelessly, but more typically there are various intermediaries in their communication such as wireless routers, gateways, and/or other internet infrastructure components.

The operation of the system 10 will now be described with reference to FIG. 1. The system 10 is configured to provide lubrication to the first lubrication point 24 and to the second lubrication point 26 when needed, and in particular when the lubrication in the first lubrication point 24 and the second lubrication point 26 has become depleted.

The first ultrasound sensor 12 detects sound emanating from the first lubrication point 24, and transmits the resulting sound detection data to the radio node 20 via the wire 28. The second ultrasound sensor 14 likewise detects sound emanating from the second lubrication point 26, and transmits the resulting sound detection data to the radio node 20 via the wire 28. The radio node 20 then transmits the sound detection data to the cloud-based lubrication control application 22 to be analyzed.

If the lubrication in the first lubrication point 24 is becoming depleted, there will be increased friction occurring within the first lubrication point 24, which will cause the first lubrication point 24 to emit a higher than normal level of sound. This higher than normal level of sound is detected by the first ultrasound sensor 12, and is reflected in the sound detection data transmitted to the cloud-based lubrication control application 22 via the radio node 20. The cloud-based lubrication control application 22 analyzes the sound detection data and is able to determine, based on the sound detection data, that the lubrication in the first lubrication point 24 is becoming depleted.

Upon determining that the lubrication in the first lubrication point 24 is becoming depleted, the cloud-based lubrication control application 22 sends instructions, via the radio node 20, to the first auto-lubrication device 16 to activate the pump mechanism, and thereby provide lubrication to the first lubrication point 24.

If the lubrication in the second lubrication point 26 is becoming depleted, the depletion can be detected in an analogous way using the sound detection data from the second ultrasound sensor 14, and the lubrication in the second lubrication point 26 can be replenished in an analogous way using the second auto-lubrication device 18.

The system 10 is thus able to provide for the automatic replenishing of lubrication in the first lubrication point 24 and in the second lubrication point 26 of the machine when needed.

Preferably, the cloud-based lubrication control application 22 has a user interface that can be accessed by authorized users, such as through a computer or mobile device. The user interface preferably allows the user to access information about the operation of the machine and the lubrication system 10. The user interface also optionally allows the user to input various parameters and commands. For example, the user interface may allow the user to select a level of sound to be used as a threshold when determining whether or not a component of the machine requires lubrication. The threshold level of sound may be selected, for example, based on the known or expected level of sound that a given component produces when its lubrication has become depleted.

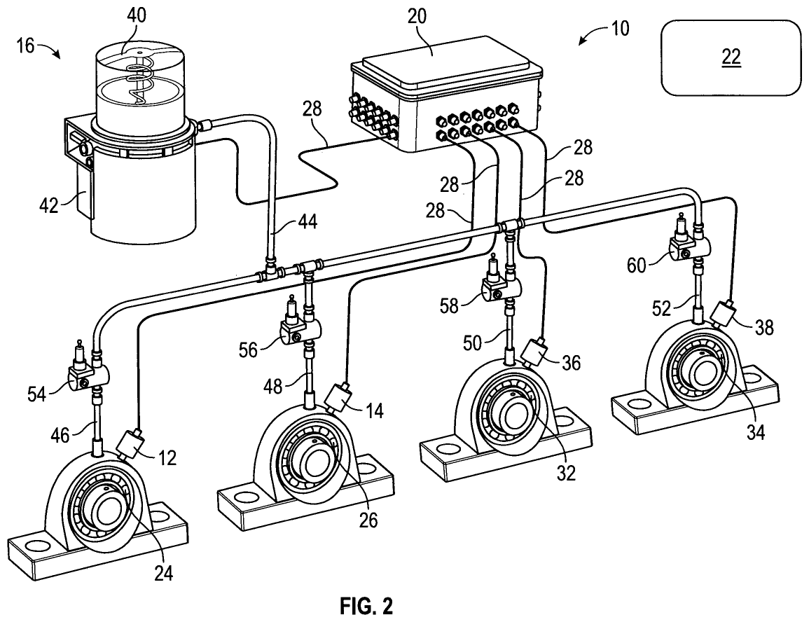

Reference is now made to FIG. 2, which depicts a system 10 for providing lubrication to a machine in accordance with a second embodiment of the present invention. Like numerals are used to denote like components. The system 10 shown in FIG. 2 is generally similar to the system 10 shown in FIG. 1, except that the system 10 shown in FIG. 2 uses a single auto-lubrication device 16 to provide lubrication to multiple different lubrication points 24, 26, 32, 34 of the machine.

The system 10 shown in FIG. 2 includes a first ultrasound sensor 12, a second ultrasound sensor 14, a third ultrasound sensor 36, a fourth ultrasound sensor 38, an auto-lubrication device 16, a radio node 20, and a cloud-based lubrication control application 22.

The first ultrasound sensor 12 is positioned adjacent to a first lubrication point 24 of the machine; the second ultrasound sensor 14 is positioned adjacent to a second lubrication point 26 of the machine; the third ultrasound sensor 36 is positioned adjacent to a third lubrication point 32 of the machine; and the fourth ultrasound sensor 38 is positioned adjacent to a fourth lubrication point 34 of the machine. Each of the first ultrasound sensor 12, the second ultrasound sensor 14, the third ultrasound sensor 36, and the fourth ultrasound sensor 38 are communicatively linked to the radio node 20 via wires 28.

The auto-lubrication device 16 includes a large reservoir 40 containing a supply of lubrication, and a lubrication pump 42 for pumping the lubrication from the reservoir 40. A main lubrication line 44 extends from the pump 42, and splits into a first lubrication line 46 that connects to the first lubrication point 24, a second lubrication line 48 that connects to the second lubrication point 26, a third lubrication line 50 that connects to the third lubrication point 32, and a fourth lubrication line 52 that connects to the fourth lubrication point 34. The first lubrication line 46 has a first solenoid valve 54 that controls the flow of lubrication to the first lubrication point 24; the second lubrication line 48 has a second solenoid valve 56 that controls the flow of lubrication to the second lubrication point 26; the third lubrication line 50 has a third solenoid valve 58 that controls the flow of lubrication to the third lubrication point 32; and the fourth lubrication line 52 has a fourth solenoid valve 60 that controls the flow of lubrication to the fourth lubrication point 34. Each of the first solenoid valve 54, the second solenoid valve 56, the third solenoid valve 58, and the fourth solenoid valve 60 are communicatively linked to the radio node 20 via a wired connection, not shown, or wirelessly.

As in the previous embodiment, the radio node 20 has a radio transmitter, not shown, for communicating with the cloud-based lubrication control application 22, and the cloud-based lubrication control application 22 is software installed on remote computers and/or computer servers for controlling the lubrication of the machine.

The operation of the system 10 will now be described with reference to FIG. 2. As in the previous embodiment, the ultrasound sensors 12, 14, 36, 38 are configured to detect sound emanating from their respective lubrication points 24, 26, 32, 34, and to transmit the resulting sound detection data to the cloud-based lubrication control application 22 via the radio node 20. The cloud-based lubrication control application 22 analyzes the data to determine whether any of the lubrication points 24, 26, 32, 34 require lubrication.

If the cloud-based lubrication control application 22 determines that a subset of the lubrication points 24, 26, 32, 34 require lubrication, such as the first lubrication point 24 and the third lubrication point 32, the cloud-based lubrication control application 22 will transmit instructions to the auto-lubrication device 16 via the radio node 20. More specifically, the cloud-based lubrication control application 22 will transmit instructions to the first solenoid valve 54 and to the third solenoid valve 58 to open, allowing lubrication pumped from the lubrication reservoir 40 to pass through the first lubrication line 46 and the third lubrication line 50 to the first lubrication point 24 and the third lubrication point 32, respectively. The valves 56, 60 controlling the flow of lubrication to the lubrication points 26, 34 determined not to require lubrication, namely the second lubrication point 26 and the fourth lubrication point 34, remain closed.

Optionally, the lubrication pump 42 is configured to maintain a given pressure within the main lubrication line 44 at all times, so that the lubrication will flow into a lubrication point 24, 26, 32, 34 whenever the corresponding solenoid valve 54, 56, 58, 60 is opened. Alternatively, the pump 42 could be configured to be activated only when instructions to provide lubrication are received from the cloud-based lubrication control application 22 via the radio node 20.

As in the previous embodiment, the cloud-based lubrication control application 22 preferably has a user interface that allows an authorized user to set and/or adjust various parameters and commands used to control the lubrication of the machine. Optionally, the cloud-based lubrication control application 22 can be used to control the lubrication of a variety of industrial machines that are under the management of the user.

It will be understood that, although various features of the invention have been described or depicted with respect to one or another of the embodiments of the invention, the various features and embodiments of the invention may be combined or used in conjunction with other features and embodiments of the invention as described and illustrated herein.

The invention is not limited to the particular embodiments and structures shown in the drawings. Rather, any suitable structures and components that can provide the functionality of the invention could be used. For example, in alternative embodiments of the invention different types of valves could be used, instead of solenoid valves 54, 56, 58, 60. Any of the wired connections could be replaced by wireless connections, and any of the wireless connections could be replaced by wired connections. The sound sensors 12, 14, 36, 38 may be selected to detect sounds of any desired frequency and amplitude, and are not strictly limited to detecting ultrasound.

In some embodiments of the invention, the system 10 may be configured to provide lubrication to a component until the sound emanating from that component returns to a normal sound level and/or falls below a threshold sound level. Other methods of controlling the lubrication could also be used, such as providing a set volume of lubrication or providing lubrication for a set amount of time. Optionally, if the sound emanating from a component does not return to a normal level after the lubrication has been provided, the system 10 may be configured to trigger a maintenance event.

Although this disclosure has described and illustrated certain preferred embodiments of the invention, it is to be understood that the invention is not restricted to these particular embodiments. Rather, the invention includes all embodiments which are functional, computational, electrical or mechanical equivalents of the specific embodiments and features that have been described and illustrated herein.

We claim:

1. A system for providing lubrication to a machine, the system comprising:
at least one sound sensor positioned to detect sound emanating from at least one lubrication point of the machine; and
at least one auto-lubrication device configured to provide lubrication to the at least one lubrication point;
wherein the at least one auto-lubrication device is controlled to provide lubrication to the at least one lubrication point based at least in part on sound detection data from the at least one sound sensor.

2. The system according to claim 1, further comprising at least one communication device configured to receive the sound detection data from the at least one sound sensor and to transmit the sound detection data to a lubrication control application;
wherein the lubrication control application controls the at least one auto-lubrication device based at least in part on the sound detection data.

3. The system according to claim 2, wherein the lubrication control application is configured to analyze the sound detection data to determine whether the at least one lubrication point is producing sounds indicative of a need for lubrication; and
wherein the lubrication control application, upon determining that the at least one lubrication point is producing sounds indicative of a need for lubrication, sends instructions via the at least one communication device to the at least one auto-lubrication device to provide lubrication to the at least one lubrication point.

4. The system according to claim 3, wherein the at least one communication device transmits the sound detection data to the lubrication control application at set intervals over time; and
wherein the lubrication control application analyzes the sound detection data received over multiple intervals to determine whether the at least one lubrication point requires lubrication.

5. The system according to claim 4, wherein the lubrication control application calculates an average sound level based on the sound detection data received over a plurality of the set intervals, and compares the average sound level to a threshold sound level; and
wherein the lubrication control application, upon determining that the average sound level exceeds the threshold sound level, controls the at least one auto-lubrication device to provide lubrication to the at least one lubrication point.

6. The system according to claim 5, wherein the at least one communication device transmits the sound detection data to the lubrication control application about once every minute; and
wherein the lubrication control application calculates the average sound level based on the sound detection data received over a time period of about 10 minutes.

7. The system according to claim 2, wherein the lubrication control application controls the at least one auto-lubrication device based in part on stored data related to lubrication requirements of the machine.

8. The system according to claim 2, wherein the lubrication control application is configured to determine, based on the sound detection data, whether the sound emanating from the at least one lubrication point exceeds a threshold value; and
wherein the lubrication control application, upon determining that the sound emanating from the at least one lubrication point exceeds the threshold value, controls the at least one auto-lubrication device to provide lubrication to the at least one lubrication point until the sound emanating from the at least one lubrication point falls to or below the threshold value.

9. The system according to claim 2, wherein the at least one sound sensor comprises multiple sound sensors, and the at least one lubrication point comprises multiple lubrication points;
wherein each of the multiple sound sensors is positioned to detect the sound emanating from a respective one of the multiple lubrication points;
wherein the at least one auto-lubrication device comprises:
a lubrication pump with a lubrication reservoir;
multiple lubrication lines that connect the lubrication pump to each of the multiple lubrication points; and
multiple valves that each control a flow of the lubrication through one of the multiple lubrication lines to one of the multiple lubrication points;
wherein the at least one communication device receives the sound detection data from each of the multiple sound sensors and transmits the sound detection data to the lubrication control application;
wherein the lubrication control application analyzes the sound detection data to determine if any of the multiple lubrication points require lubrication; and
wherein the lubrication control application, upon determining that a subset of the multiple lubrication points require lubrication, sends instructions via the at least one communication device to a subset of the multiple valves to provide lubrication to the subset of the multiple lubrication points.

10. The system according to claim 1, wherein the at least one sound sensor comprises at least one ultrasound sensor.

11. The system according to claim 2, wherein the at least one communication device comprises at least one radio node.

12. The system according to claim 2, wherein the lubrication control application comprises a cloud-based lubrication control application.

13. The system according to claim 9, wherein the valves comprise solenoid valves.

14. The system according to claim 2, wherein the lubrication control application is configured to generate or adjust a lubrication schedule for the machine based at least in part on the sound detection data received from the at least one sound sensor over time.

15. The system according to claim 6, wherein the lubrication control application controls the at least one auto-lubrication device based in part on stored data related to lubrication requirements of the machine;
wherein the at least one sound sensor comprises at least one ultrasound sensor;
wherein the at least one communication device comprises at least one radio node; and
wherein the lubrication control application comprises a cloud-based lubrication control application.

16. The system according to claim 15, wherein the at least one sound sensor comprises multiple sound sensors, and the at least one lubrication point comprises multiple lubrication points;
wherein each of the multiple sound sensors is positioned to detect the sound emanating from a respective one of the multiple lubrication points;
wherein the at least one auto-lubrication device comprises:
a lubrication pump with a lubrication reservoir;
multiple lubrication lines that connect the lubrication pump to each of the multiple lubrication points; and
multiple valves that each control a flow of the lubrication through one of the multiple lubrication lines to one of the multiple lubrication points;
wherein the at least one communication device receives the sound detection data from each of the multiple sound sensors and transmits the sound detection data to the lubrication control application;
wherein the lubrication control application analyzes the sound detection data to determine if any of the multiple lubrication points require lubrication; and
wherein the lubrication control application, upon determining that a subset of the multiple lubrication points require lubrication, sends instructions via the at least one communication device to a subset of the multiple valves to provide lubrication to the subset of the multiple lubrication points.

17. The system according to claim 8, wherein the lubrication control application is configured to analyze the sound detection data to determine whether the at least one lubrication point is producing sounds indicative of a need for lubrication;
wherein the lubrication control application, upon determining that the at least one lubrication point is producing sounds indicative of a need for lubrication, sends instructions via the at least one communication device to the at least one auto-lubrication device to provide lubrication to the at least one lubrication point;
wherein the at least one sound sensor comprises at least one ultrasound sensor;
wherein the at least one communication device comprises at least one radio node; and
wherein the lubrication control application comprises a cloud-based lubrication control application.

18. The system according to claim 17, wherein the at least one sound sensor comprises multiple sound sensors, and the at least one lubrication point comprises multiple lubrication points;
wherein each of the multiple sound sensors is positioned to detect the sound emanating from a respective one of the multiple lubrication points;
wherein the at least one auto-lubrication device comprises:
a lubrication pump with a lubrication reservoir;
multiple lubrication lines that connect the lubrication pump to each of the multiple lubrication points; and
multiple valves that each control a flow of the lubrication through one of the multiple lubrication lines to one of the multiple lubrication points;
wherein the at least one communication device receives the sound detection data from each of the multiple sound sensors and transmits the sound detection data to the lubrication control application;
wherein the lubrication control application analyzes the sound detection data to determine if any of the multiple lubrication points require lubrication; and
wherein the lubrication control application, upon determining that a subset of the multiple lubrication points require lubrication, sends instructions via the at least one communication device to a subset of the multiple valves to provide lubrication to the subset of the multiple lubrication points.

19. The system according to claim 18, wherein the valves comprise solenoid valves; and
wherein the lubrication control application is configured to generate or adjust a lubrication schedule for the machine based at least in part on the sound detection data received from the at least one sound sensor over time.

20. A method of providing lubrication to a machine, comprising:
positioning at least one sound sensor to detect sound emanating from at least one lubrication point of the machine; and
controlling at least one auto-lubrication device to provide lubrication to the at least one lubrication point based at least in part on sound detection data from the at least one sound sensor.
